(19) United States
(12) Patent Application Publication
(10) Pub. No.: US 2016/0292130 A1
(43) Pub. Date: Oct. 6, 2016

(54) LEGACY DOCUMENT CONVERTER FOR A MOBILE DEVICE

(71) Applicant: International Business Machines Corporation, Armonk, NY (US)

(72) Inventors: Hao Gao, Xian (CN); Jinzhi Han, Xi'an (CN); Tao Sha, Xi'an (CN); Jiancheng Si, Xi'an (CN)

(21) Appl. No.: 14/677,453

(22) Filed: Apr. 2, 2015

(51) Int. Cl. G06F 17/21; G06T 3/40

(52) U.S. Cl. CPC G06F 17/211; G06T 3/40

(57) ABSTRACT

A computer receives a document which contains one or more fixed sizes that make viewing on the smaller screens of a mobile devices difficult or otherwise impossible. The computer identifies what role the nodes contained in the document will fulfill when generated in a scalable, grid-like format capable of being viewed on smaller screens. The computer identifies and assigns grid positions to the nodes of the document such that the original locations of the nodes of the document are maintained when generated in the viewable format. The computer annotates the document with the identified roles and assigned grid positions such that a mobile adapter may process the annotations in order to generate the document in a format viewable on smaller screen sizes.

### TECHNICAL FIELD

The present invention relates generally to document format conversion, and more particularly to converting legacy business intelligence reports into viewable formats on a mobile device.

### BACKGROUND

The introduction of mobile devices such as smart phones and tablets provides mobile access to documents that were once only available on the large screens of desktop and laptop computers. Unfortunately, adapting the legacy documents which were designed to be viewed on large computer screens to the smaller screens of mobile devices often times results in parts of a document being difficult to see or not displayed whatsoever. This is caused by fixed layouts, fixed container sizes, and fixed content sizes that exceed the display size of mobile devices.

### SUMMARY

Embodiments of the present invention disclose a method, system, and computer program product for adapting legacy business intelligence reports into formats that are viewable on mobile devices. A computer receives a document which contains one or more fixed sizes that make viewing on the smaller screens of a mobile devices difficult or otherwise impossible. The computer identifies what role the nodes contained in the document will fulfill when generated in a scalable, grid-like format capable of being viewed on smaller screens. The computer identifies and assigns grid positions to the nodes of the document such that the original locations of the nodes of the document are maintained when generated in the viewable format. The computer annotates the document with the identified roles and assigned grid positions such that a mobile adapter may process the annotations in order to generate the document in a format viewable on smaller screen sizes.

### BRIEF DESCRIPTION OF THE SEVERAL VIEWS OF THE DRAWING

FIG. 1 illustrates a legacy document converter for a mobile device system, in accordance with an embodiment of the invention.

FIG. 2 is a flowchart illustrating the operation of a legacy document converter for the mobile device program of FIG. 1 in adapting legacy business intelligence reports into formats viewable on mobile devices, in accordance with an embodiment of the invention.

FIG. 3 is a block diagram depicting the hardware components of a legacy document converter for the mobile device system of FIG. 1, in accordance with an embodiment of the invention.

### DETAILED DESCRIPTION

Embodiments of the present invention will now be described in detail with reference to the accompanying figures.

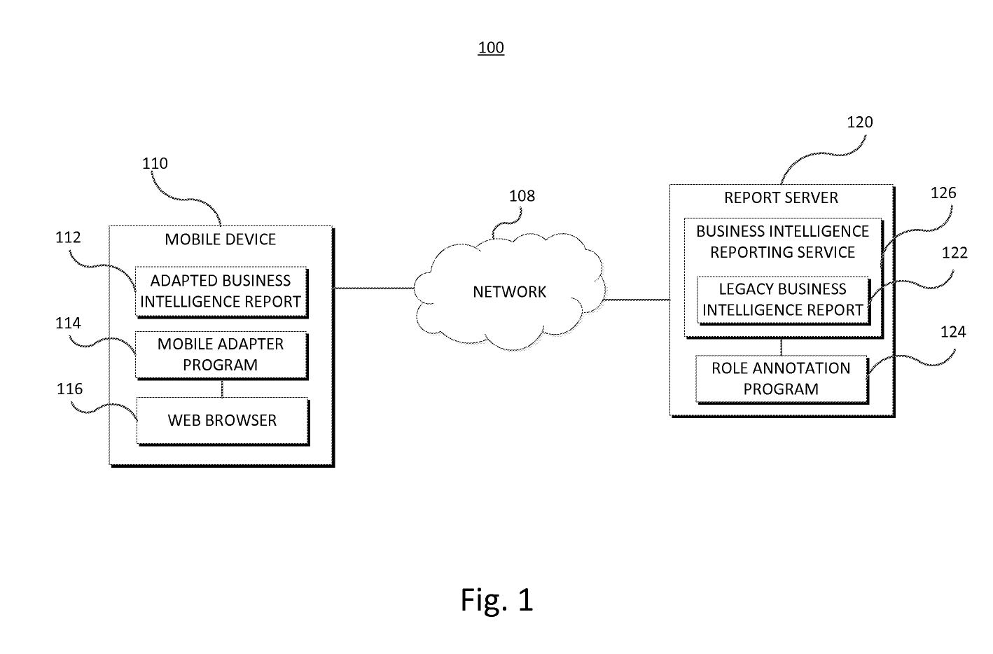

FIG. 1 illustrates a legacy document converter for the mobile device. In the example embodiment, legacy document converter for the mobile device system 100 includes mobile device 110, network 108, and report server 120.

In the example embodiment, network 108 may be the Internet, representing a worldwide collection of networks and gateways to support communications between devices connected to the Internet. Network 108 may include, for example, wired, wireless or fiber optic connections. In other embodiments, network 108 may be implemented as an intranet, a local area network (LAN), or a wide area network (WAN). In general, network 108 can be any combination of connections and protocols that will support communications between mobile device 110 and report server 120.

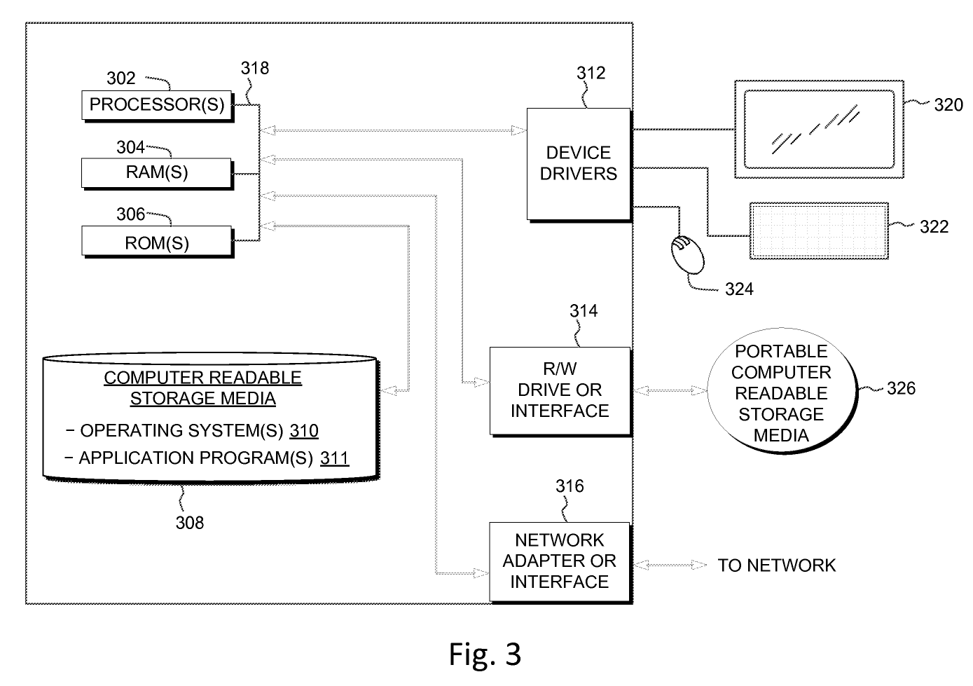

Report server 120 may include business intelligence reporting service 126 and role annotation program 124. In the example embodiment, report server 120 may be a desktop computer, a notebook, a laptop computer, a tablet computer, a handheld device, a smart-phone, a thin client, or any other electronic device or computing system capable of receiving and sending data to and from other computing devices, such as mobile device 110, via network 108. While report server 120 is shown as a single device, in other embodiments, report server 120 may be comprised of a cluster or plurality of computing devices, working together or working separately. Report server 120 is described in more detail with reference to FIG. 3.

Business intelligence reporting service 126 includes legacy business intelligence report 122. In the example embodiment, business intelligence reporting service 126 transforms large amounts of raw and unstructured data into business intelligence reports for business analysis purposes. In the example embodiment, business intelligence reporting service 126 utilizes techniques such as data mining, process mining, complex event processing, benchmarking, and other techniques to generate business intelligence reports, such as legacy business intelligence report 122.

Legacy business intelligence report 122 may be a document summarizing and detailing the results of the business analysis performed by business intelligence reporting service 126. In the example embodiment, the nodes and layout of legacy business intelligence report 122 have fixed sizes designed to be viewed on the larger screens of desktop/laptop computers and, as a result, legacy business intelligence report 122 is often times difficult or impossible to view on the smaller screens of mobile devices, such as mobile device 110. In the example embodiment, legacy business intelligence report 122 is a Hypertext Markup Language (HTML) document, however in other embodiments, legacy business intelligence report 122 may be a different document type which may have fixed nodes and layout sizes which may be difficult to view on smaller screen sizes.

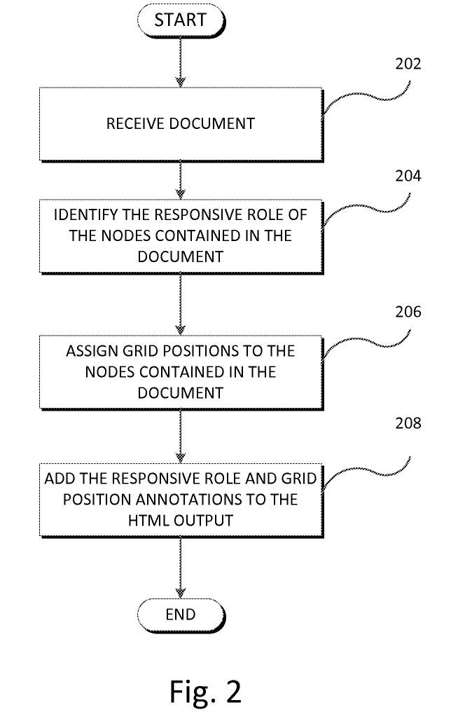

Role annotation program 124 is a software program that may be integrated with business intelligence reporting service 126 on report server 120. In the example embodiment, role annotation program 124 may be capable of parsing the nodes of a Report Object Model (ROM), such as the nodes contained in the ROM of legacy business intelligence report 122. In addition, role annotation program 124 may be capable of identifying the responsive role of relevant nodes in a ROM, including responsive roles such as row nodes, static nodes, and sequence nodes. The responsive roles are used by a mobile adapter program, such as mobile adapter program 114, to generate legacy business intelligence report 122 in a format viewable on mobile devices. When generated in a viewable format, row nodes are generated as row containers, static nodes are generated as child content, and sequence nodes are generated as a row container as well as child content (responsive roles of nodes are described in greater detail in step 204 of the FIG. 2 discussion). Role annotation program 124 may be further capable of assigning grid positions to the ROM nodes of legacy business intelligence report 122 which may be utilized by a mobile adapter program to generate a business intelligence report in a viewable layout on a mobile device. Grid positions may indicate to a mobile adapter program, such as mobile adapter program 114, where to generate the nodes such that the overall layout of the document is maintained when generated in a viewable format (grid positions of the nodes are described in greater detail in step 206 of the FIG. 2 discussion). Role annotation program 124 may be further capable of annotating the HTML of legacy business intelligence report 122 with the identified responsive roles and assigned grid positions such that a mobile adapter program, such as mobile adapter program 114, may be capable of processing the HTML tags to generate legacy business intelligence report 122 in a format viewable on smaller screen sizes.

Mobile device 110 includes adapted business intelligence report 112, mobile adapter 114, and web browser 116. In the example embodiment, mobile device 110 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices, such as report server 120, via network 108. In the example embodiment, mobile device 110 may be incapable of viewing legacy documents, such as legacy business intelligence report 122, properly due to fixed sizes of nodes and layouts that are larger than the screen of mobile device 110. While mobile device 110 is shown as a single device, in other embodiments, mobile device 110 may be comprised of a cluster or plurality of computing devices, working together or working separately. Mobile device 110 is described in more detail with reference to FIG. 3.

Web browser 116 may be a software application for retrieving, presenting, and traversing informational resources on the World Wide Web. In the example embodiment, web browser 116 may be integrated with mobile adapter program 114 and may be capable of opening documents, such as HTML documents, on mobile device 110. In the example embodiment, web browser 116 may be capable of communicating with other computing devices, such as report server 120, via a network, such as network 108.

Mobile adapter program 114 may be a software program integrated with web browser 116 that may be capable of processing the HTML tags of a legacy business intelligence report, such as the HTML tags added by role annotation program 124 to legacy business intelligence report 122. Additionally, mobile adapter program 114 may be capable of utilizing the processed HTML tags to generate business intelligence reports with a responsive, scalable, grid-like layout on the smaller screens of mobile devices, such as mobile device 110.

Adapted business intelligence report 112 is a business intelligence report, such as legacy business intelligence report 122, which may have been adapted by mobile adapter program 114 to a functional layout that is responsive on mobile device 110 using the annotations added by role annotation program 124. In the example embodiment, adapted business intelligence report 112 may be an HTML document, however in other embodiments, adapted business intelligence report 112 may be a different document type.

FIG. 2 is a flowchart depicting the operation of a legacy document converter for the mobile device in adapting legacy business intelligence reports into responsive formats on mobile devices, in accordance with an embodiment of the present invention. In order to display legacy documents on smaller screen sizes, legacy document converter for the mobile device annotates a legacy business intelligence report such that a mobile converter is capable of utilizing the annotations to regenerate the legacy business intelligence report into a scalable, spreadsheet-like grid which is viewable on the smaller screens of mobile devices.

In the example embodiment where role annotation program 124 is integrated with business intelligence reporting service 126 on report server 120, role annotation program 124 receives legacy business intelligence report 122 by loading the document (step 202). In other embodiments where role annotation program 124 is not integrated with business intelligence reporting service 126, role annotation program 124 may receive legacy business intelligence report 122 by way of other input means such as a user, method, or system. For example, legacy business intelligence report 122 may detail television product pricing guidelines that were obtained by business intelligence reporting service 126 through data mining both large amounts of external data from the relevant market and the internal business data relevant to finance and operations.

Role annotation program 124 identifies the responsive role of the nodes in the Report Object Model (ROM) of legacy business intelligence report 122 by identifying what responsive role the nodes will play when generated in a grid-like layout by mobile adapter program 114 by mobile adapter program 114 (step 204). Along with assigned grid positions (discussed in more detail in step 206), the responsive roles of three types of nodes in the ROM of legacy business intelligence report 122 are utilized by mobile adapter program 114 to generate the grid layout of adapted business intelligence report 112: row nodes, static nodes, and sequence nodes.

Role annotation program 124 identifies row nodes as nodes capable of containing additional nodes. Common row nodes include page headers, page footers, page bodies, and table rows. Nodes identified as row nodes are adapted by mobile adapter program 114 into row containers because row containers are capable of performing many of the same functions as row nodes. Specifically, both a row node and row container are capable of nesting additional content: row nodes may contain additional nodes while a row container may contain additional content. However, unlike a row node which has a fixed size, a row container is scalable to the screen size of a mobile device such as mobile device 110. The content nested in a row container is placed in column containers (twelve column containers are supplied with every row container) within the row container much like a row in a spreadsheet contains content in individual columns, forming cells. For example, if the ROM of legacy business intelligence report 122 includes a page header, then the page header node is identified by role annotation program 124 as a row node because a row container will play the role of the page header row node when adapted business intelligence report is generated.

Role annotation program 124 identifies static nodes as nodes that are indivisible and generates content as a whole part, such as an image, text item, chart, list, crosstab, date, or time. Nodes identified as static nodes by role annotation program 124 are generated as child content by mobile adapter program 114 in adapted business intelligence report 112. Child content is nested in the column container of the parent row container much like content in a cell of a spreadsheet. Because child content is scaled to the size of the container in which it is contained, scaling the parent container that contains child content to the size of mobile device 110 will proportionally scale child content as well. Continuing the example above where legacy business intelligence report 122 includes a page header node identified as a row node, if the page header also contains a text node and an image node, then role annotation program 124 identifies the text node and image node as static nodes. Furthermore, when generated by mobile adapter program 114 as adapted business intelligence report 112, then the text node and image node are nested as static nodes within the columns of the parent page header row container as children.

Role annotation program 124 identifies a node as a sequence node when the node contains multiple children content, such as a data button group or checkbox group. Nodes annotated as sequence nodes are generated in adapted business intelligence report 112 by mobile adapter program 114 as a parent row container as well as child content contained within column containers of the parent row container. A sequence node is generated in adapted business intelligence report 112 much like a row of a spreadsheet containing content in the cells of multiple columns. Continuing the example above where legacy business intelligence report 122 includes a page header identified as a row node, if the page header node also contains a button bar node, then the button bar node is identified as a sequence node and generated as a child row container within the page header parent row container. Furthermore, the buttons of the sequence node button bar are nested as child content within the column containers of the sequence node row container and the sequence node row container is nested in the page header parent row container.

Role annotation program 124 assigns grid positions to the nodes contained in the ROM of legacy business intelligence report 122 (step 206). The grid positions are assigned based on the location of the nodes in legacy business intelligence report 122 such that when adapted by mobile adapter program 114, adapted business intelligence report 112 displays the adapted nodes in relatively the same position. In the example embodiment, the grid comprises twelve (12) column containers per row, an unlimited amount of rows, and is scalable based on the screen size of mobile device 110. If the amount of column containers required in a single row container exceeds twelve (12), a second parent row container is generated to nest any overflow column containers. When fewer than twelve (12) column containers are present, column containers can be grouped together to form larger spanning column containers, such as three (3) sequence nodes occupying four (4) column containers each or two (2) sequence nodes occupying six (6) column containers each. In other embodiments, grid size and functionality may vary based on factors such as document type and layout.

Role annotation program 124 annotates the responsive role and grid position of each node to the HTML output of legacy business intelligence report 122 (step 208). The annotations are embedded directly into legacy business intelligence report 122 and have no effect on the viewing of legacy business intelligence report 122 on larger screen sizes. In addition, the annotations are lightweight, meaning that they do not substantially increase the file size of legacy business intelligence report 122. The annotations are then processed by mobile adapter program 114 to generate adapted business intelligence report 112 in a responsive layout on mobile device 110.

FIG. 3 depicts a block diagram of components of mobile device 110 of a legacy document converter for a mobile device system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Mobile device 110 may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311, for example, role annotation program 124, are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Mobile device 110 may also include a R/W drive or interface 314 to read from and write to one or more portable computer readable storage media 326. Application programs 311 on mobile device 110 may be stored on one or more of the portable computer readable storage media 326, read via the respective R/W drive or interface 314 and loaded into the respective computer readable storage media 308.

Mobile device 110 may also include a network adapter or interface 316, such as a TCP/IP adapter card or wireless communication adapter (such as a 4G wireless communication adapter using OFDMA technology). Application programs 311 on mobile device 110 may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Mobile device 110 may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

Various embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-7. (canceled)

8. A computer program product for converting an electronic document for viewing on a mobile device, the computer program product comprising:
one or more computer-readable storage media and program instructions stored on the one or more computer-readable storage media, the program instructions comprising:
program instructions to receive a first electronic document having display properties that differ from the display properties of the mobile device, wherein the first electronic document includes one or more nodes;
program instructions to identify a role of the one or more nodes, wherein the roles include at least one of a row node, a static node, and a sequence node;
program instructions to assign a grid position to each of the one or more nodes, wherein the grid position corresponds to a position of the one or more nodes in the first electronic document; and
program instructions to annotate the first electronic document with the identified role and assigned one or more grid positions of the one or more nodes.

9. The computer program product of claim 8, further comprising:
program instructions to generate a second electronic document based on the annotated role and annotated grid position of the one or more nodes,
whereby the second electronic document is displayable on the mobile device.

10. The computer program product of claim 9, wherein generating the second electronic document is performed by a mobile adapter.

11. The computer program product of claim 10, wherein the mobile adapter generates the row node as a row container, the static node as a child content, and the sequence node as both a child content and a row container.

12. The computer program product of claim 8, wherein the grid position is based on a grid of twelve column containers and an unlimited number of row containers.

13. The computer program product of claim 8, wherein the grid is scalable based on a screen size of the mobile device.

14. The computer program product of claim 10, wherein the mobile adapter is stored on the mobile device.

15. A computer system for converting an electronic document for viewing on a mobile device system, the computer system comprising:
one or more computer processors, one or more computer-readable storage media, and program instructions stored on one or more of the computer-readable storage media for execution by at least one of the one or more processors, the program instructions comprising:
program instructions to receive a first electronic document having display properties that differ from the display properties of the mobile device, wherein the first electronic document includes one or more nodes;
program instructions to identify a role of the one or more nodes, wherein the roles include at least one of a row node, a static node, and a sequence node;
program instructions to assign a grid position to each of the one or more nodes, wherein the grid position corresponds to a position of the one or more nodes in the first electronic document; and
program instructions to annotate the first electronic document with the identified role and assigned one or more grid positions of the one or more nodes.

16. The computer system of claim 15, further comprising:
program instructions to generate a second electronic document based on the annotated role and annotated grid position of the one or more nodes,
whereby the second electronic document is displayable on the mobile device.

17. The computer system of claim 16, wherein generating the second electronic document is performed by a mobile adapter.

18. The computer system of claim 17, wherein the mobile adapter generates the row node as a row container, the static node as a child content, and the sequence node as both a child content and a row container.

19. The computer system of claim 15, wherein the grid position is based on a grid of twelve column containers and an unlimited number of row containers.

20. The computer system of claim 15, wherein the grid is scalable based on a screen size of the mobile device.
